(19) United States
(12) Patent Application Publication
(10) Pub. No.: US 2019/0041908 A1
(43) Pub. Date: Feb. 7, 2019

(54) ULTRATHIN, WATERPROOF AND SOUND-PERMEABLE COMPOSITE MODULE

(71) Applicant: Suzhou Xiaoyijia Optronics Technology Co., Ltd, Suzhou (CN)

(72) Inventors: Dan QIU, Suzhou (CN); Xinlei MAO, Suzhou (CN)

(21) Appl. No.: 15/869,547

(22) Filed: Jan. 12, 2018

(30) Foreign Application Priority Data
Aug. 2, 2017 (CN) 201710653024.0

(51) Int. Cl. G06F 1/16; G06F 1/18

(52) U.S. Cl. CPC G06F 1/1626; G06F 1/182; G06F 1/1688

(57) ABSTRACT

The invention discloses an ultrathin, waterproof and sound-permeable composite module, which comprises a waterproof and sound-permeable composite module body, wherein the waterproof and sound-permeable composite module body comprises a metal matrix, an adhesive and a waterproof sound-permeable membrane, the metal matrix is bonded to the waterproof sound-permeable membrane by the adhesive, the metal matrix is provided with a step, the step is integrally formed with the metal matrix, the step is divided into a first step and a second step, and the adhesive is arranged as a single-component epoxy system thermosetting adhesive. In place of traditional die-cut articles, the ultrathin, waterproof and sound-permeable composite module of the invention is bonded to a product, thus fundamentally solving the problems that the traditional die-cut articles have poor uniformity, difficulty in mass production and wide adhered glue.

### FIELD OF THE INVENTION

The invention relates to the field of smart phones, smart wearable devices, smart homes as well as other smart equipment and instruments having acoustical requirements, and particularly to an ultrathin, waterproof and sound-permeable composite module.

### BACKGROUND OF THE INVENTION

In recent years, die-cut products have been widely applied. A die-cut article is made by supporting PTFE or a soft material with a double-sided adhesive or foam, but the existing die-cut articles basically have the following defects: 1. the die-cut articles are relatively soft and hence have very poor uniformity, wherein the uniformity of the die-cut articles involves the requirements on acoustics, air permeability and waterproof rating, most of the die-cut articles have acoustical requirements, but it is very difficult to ensure that each piece of the die-cut articles can meet such requirements during production, and because substrates for the die-cut articles are very soft, stacking more layers of the die-cut articles requires higher machining requirements and precision, and the die-cut articles will be deformed upon stacking, thus greatly affecting the die-cut articles and products to be adhered; 2. difficulty in mass production: traditional die-cut articles are hardly gripped or adsorbed by a mechanical hand or a sucking disc and generally manually adhered piece by piece according to their material characteristics, thus wasting a lot of manpower and material resources, and providing limited operational stability; and 3. traditional die-cut products are adhered by double-sided adhesives, but double-sided adhesives cannot meet the requirements on adhesive strength due to their limited adhesive force, double-sided adhesives or other adhesives having an adhering space with a one-side glue width of greater than 1 MM and a two-side glue width of greater than 2 MM are generally used in the industry, but such traditional die-cut products have very large glue width, which will affect the practical effects and aesthetics of electronic products, and with the development trend of electronic products, currently the refinement degree of electronic products is increased, the size of electronic products is getting smaller and smaller, and a limited adhering space is provided by electronic products.

However, the product of the invention solves the above problems, and replaces traditional die-cut articles by using a metal part. Firstly, the invention solves the problem of poor uniformity, wherein a metal part is bonded to a waterproof sound-permeable membrane by a single-component epoxy system thermosetting adhesive, and the metal part has relatively good uniformity due to its material, which is further reflected in acoustics; next, traditional die-cut articles are relatively soft after die cutting due to their materials and hence need to be manually taken out, but the metal part can be automatically operated by a mechanical hand in the mass production process due to its material, which provides higher efficiency than traditional die-cut articles; besides, the product of the invention will ensure a great change in pore diameter under the conditions of a certain space and the same outer diameter, wherein double-sided adhesives of traditional die-cut articles have a one-side glue width of greater than 1 mm while a minimum one-side glue width of 0.15 mm is achieved in the process of the invention, and therefore the direct pore diameter becomes greater, which greatly improves acoustical requirements due to the fact that the influence on acoustics is associated with pore diameter, membranes and sound channels, thus the metal matrix of the invention completely solves the problem regarding acoustics of traditional die-cut articles; and next, the invention has low cost, wherein materials for traditional die-cut articles are expensive, and the cost increases with the increase of production output, but an ultrathin, waterproof and sound-permeable composite module of the invention has lower cost with the increase of production output, and the prime cost is equipment cost.

### SUMMARY OF THE INVENTION

An object of the invention is to overcome the above problems existing in the prior art, and provide an ultrathin, waterproof and sound-permeable composite module which is bonded to a product in place of traditional die-cut articles, thus fundamentally solving the problems that the traditional die-cut articles have poor uniformity, difficulty in mass production and wide adhered glue.

To achieve the above technical object and technical effects, the invention is realized by the following technical solution.

An ultrathin, waterproof and sound-permeable composite module comprises a waterproof and sound-permeable composite module body, wherein the waterproof and sound-permeable composite module body comprises a metal matrix, an adhesive and a waterproof sound-permeable membrane, the metal matrix is bonded to the waterproof sound-permeable membrane by the adhesive, the metal matrix is provided with a step, the step is integrally formed with the metal matrix, the step comprises a first step and a second step, the adhesive is arranged as a single-component epoxy system thermosetting adhesive, and the first step 4 is located on the metal matrix 1.

Further, the thickness of the waterproof and sound-permeable composite module body is arranged to be 0.01-0.3 mm.

Further, the metal matrix is formed by stamping or etching or forging and stamping or CNC machining or powder metallurgy processing.

Further, the inner diameter of the second step is not smaller than that of various shapes having an equivalent area based on φ0.08, and the height of the second step is arranged to be below 0.15 mm.

Further, several perforations are also arranged on the first step of the metal matrix, and the pore diameter range of the perforations is arranged to be 0.05-0.3 MM.

Further, the contour shapes of the metal matrix include a circle or a square or different customized shapes obtained according to the demand.

Further, the metal matrix is made of copper, aluminum, iron or stainless steel and an alloy material thereof.

Further, the bonding between the metal matrix and the waterproof sound-permeable membrane further includes pressure sensitive adhesive bonding or UV curing bonding or moisture curing bonding or thermosetting bonding or AB glue bonding or hot-melt adhesive film bonding or welding; and the bonding between the metal matrix and the waterproof sound-permeable membrane includes but is not limited to the above bonding.

The beneficial effects of the invention are as follows:

1. the composite module solves the problem of poor uniformity in traditional die-cut articles, further replaces the traditional die-cut articles in terms of acoustics and waterproof rating, and completely solves the problems caused by the material properties of the traditional die-cut articles;

2. the composite module is suitable for batch production, and therefore can be automatically operated with higher efficiency by a mechanical hand in the mass production process when compared with the traditional die-cut articles, thus saving a lot of manpower and material resources, and providing high operational stability;

3. the composite module solves the problem of large glue width in the traditional die-cut articles, thus providing a greater space to adhere an electronic product; and

4. the composite module has low cost.

The above description is only a general description of the technical solution of the invention. In order that a technical means of the invention can be understood more clearly and can be implemented according to the contents of the specification, the technical means will be described hereinafter in detail through a preferred embodiment of the invention and the drawings, and a particular embodiment of the invention will be provided in detail by the following embodiment and its drawings.

### BRIEF DESCRIPTION OF THE DRAWINGS

The drawings illustrated herein are used to provide a further understanding of the invention and constitute a part of the present application, and illustrative embodiments and their illustrations of the invention are used for explaining the invention, but do not unduly limit the invention. In the Figures:

FIG. 1 is a schematic structural view of an ultrathin, waterproof and sound-permeable composite module involved in the invention;

FIG. 2 is a sectional view of an ultrathin, waterproof and sound-permeable composite module involved in the invention;

FIG. 3 is a schematic structural view of an ultrathin, waterproof and sound-permeable composite module involved in the invention; and

FIG. 4 is a schematic structural side view of an ultrathin, waterproof and sound-permeable composite module involved in the invention.

Description of reference numerals: metal matrix 1; adhesive 2; waterproof sound-permeable membrane 3; first step 4; second step 5; perforation 6.

### DETAILED DESCRIPTION OF THE INVENTION

The invention will be further described below with reference to the drawings.

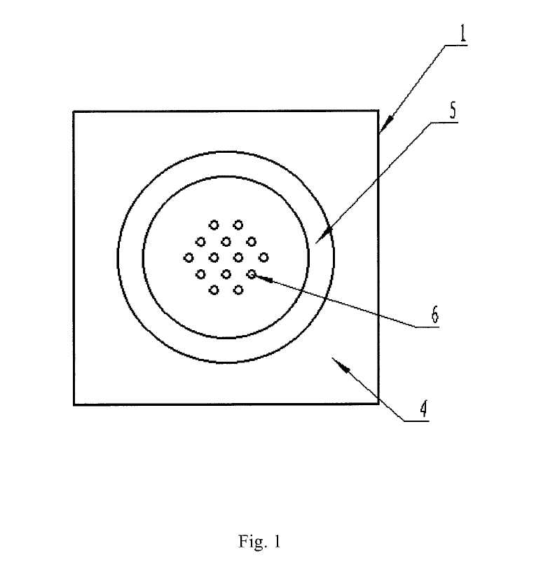

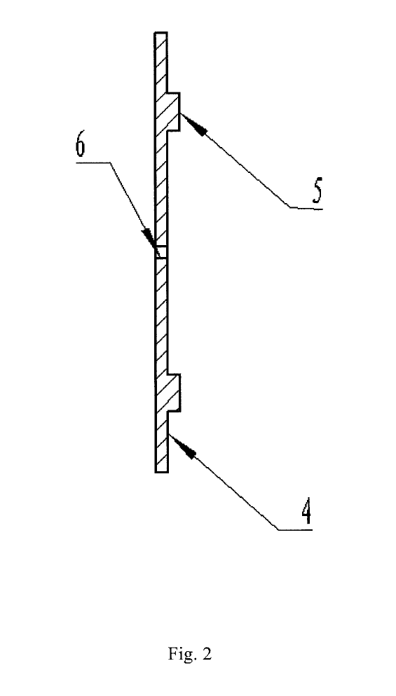

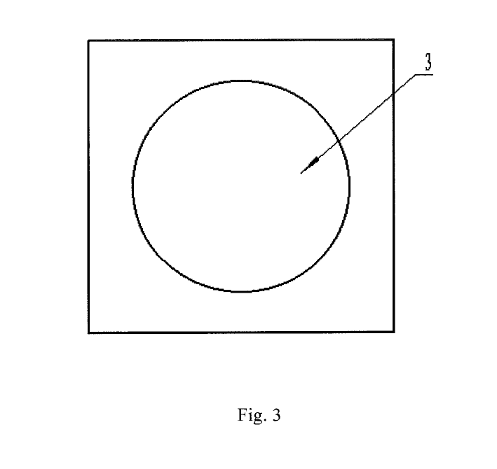

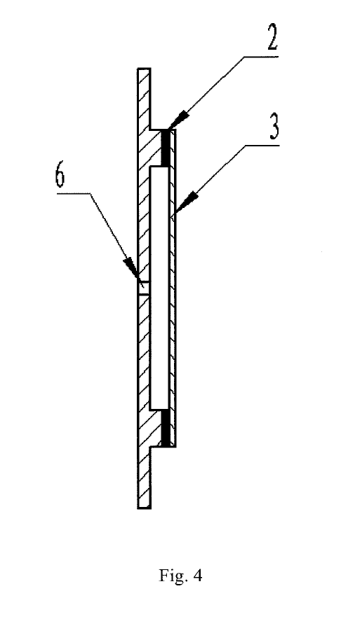

Referring to FIGS. 1 to 4, an ultrathin, waterproof and sound-permeable composite module comprises a waterproof and sound-permeable composite module body, wherein the waterproof and sound-permeable composite module body comprises a metal matrix 1, an adhesive 2 and a waterproof sound-permeable membrane 3, the metal matrix 1 is bonded to the waterproof sound-permeable membrane 3 by the adhesive 2, the adhesive 2 is arranged as a single-component epoxy system thermosetting adhesive, a step is arranged on a surface of the metal matrix 1, the step is integrally formed with the metal matrix 1, the step is divided into a first step 4 and a second step 5, several perforations 6 are arranged on the first step 4, and the first step 4 is located on the metal matrix 1.

The thickness of the waterproof and sound-permeable composite module body is arranged to be 0.01-0.3 mm as a preferred thickness, thus the thickness of the ultrathin, waterproof and sound-permeable composite module of the invention is capable of better facilitating the use of the composite module in combination with a modernized fine electronic product.

The metal matrix 1 is formed by stamping or etching or forging and stamping or CNC machining or powder metallurgy processing as a machining mode of the metal matrix 1.

The inner diameter of the second step 5 is not smaller than that of various shapes having an equivalent area based on φ0.08. The shapes of the second step 5 are not limited to a circle, a square or other shapes, and different shapes can be customized according to user demand. The inner diameter ensures a certain area to achieve better acoustical effects. The height of the second step 5 is arranged to be below 0.15 mm. The waterproof sound-permeable membrane 3 is bonded to the second step 5 on the metal matrix 1 by the adhesive 2 to allow a moderate spacing between waterproof sound-permeable membrane 3 and the metal matrix 1, thus better ensuring the acoustical performance of the waterproof sound-permeable membrane 3. Sound is not affected during sound transmission of the perforations 6, thus the permeation of the waterproof sound-permeable membrane 3 is not affected during sound transmission.

The pore diameter range of the perforations 6 is arranged to be 0.05-0.3 mm, which is an optimal pore diameter range actually measured for the protection of the waterproof sound-permeable membrane 3 and the transmission effects of sound.

The contour shapes of the metal matrix 1 include a circle or a square or different customized shapes obtained according to the demand, and the shapes of the metal matrix are not limited to a circle or a square.

The metal matrix 1 is made of such materials including copper, aluminum, iron or stainless steel and an alloy material thereof, but not limited to copper, aluminum, aluminum alloy, iron or stainless steel, and the metal matrix 1 is more favorable for mechanized gripping and adsorption operation.

The bonding between the metal matrix 1 and the waterproof sound-permeable membrane 3 further includes pressure sensitive adhesive bonding or UV curing bonding or moisture curing bonding or thermosetting bonding or AB glue bonding or hot-melt adhesive film bonding or welding; and the bonding between the metal matrix 1 and the waterproof sound-permeable membrane 3 includes but is not limited to the above bonding.

The above description is only a preferred embodiment of the invention, rather than a limitation in any form made to the invention. Any simple alternation, equivalent change and modification made on the above embodiment based on the technical substance of the invention still belong to the scope of the technical solution of the invention.

1. An ultrathin, waterproof and sound-permeable composite module, comprising a waterproof and sound-permeable composite module body, wherein the waterproof and sound-permeable composite module body comprises a metal matrix (1), an adhesive (2) and a waterproof sound-permeable membrane (3), the metal matrix (1) is bonded to the waterproof sound-permeable membrane (3) by the adhesive (2), the adhesive (2) is arranged as a single-component epoxy system thermosetting adhesive, a step is arranged on a surface of the metal matrix (1), the step is integrally formed with the metal matrix (1), the step is divided into a first step (4) and a second step (5), and several perforations (6) are arranged on the first step (4).

2. The ultrathin, waterproof and sound-permeable composite module according to claim 1, wherein the thickness of the waterproof and sound-permeable composite module body is arranged to be 0.01-0.3 mm.

3. The ultrathin, waterproof and sound-permeable composite module according to claim 1, wherein the metal matrix (1) is formed by stamping or etching or forging and stamping or CNC machining or powder metallurgy processing.

4. The ultrathin, waterproof and sound-permeable composite module according to claim 1, wherein the inner diameter of the second step (5) is not smaller than that of various shapes having an equivalent area based on φ0.08, and the height of the second step (5) is arranged to be below 0.15 mm.

5. The ultrathin, waterproof and sound-permeable composite module according to claim 1, wherein the pore diameter range of the perforations (6) is arranged to be 0.05-0.3 mm.

6. The ultrathin, waterproof and sound-permeable composite module according to claim 1, wherein the contour shapes of the metal matrix (1) include a circle or a square or different customized shapes obtained according to the demand.

7. The ultrathin, waterproof and sound-permeable composite module according to claim 1, wherein the metal matrix (1) is made of such materials including but not limited to copper, aluminum, iron or stainless steel and an alloy material thereof.

8. The ultrathin, waterproof and sound-permeable composite module according to claim 1, wherein the bonding between the metal matrix (1) and the waterproof sound-permeable membrane (3) further includes pressure sensitive adhesive bonding or UV curing bonding or moisture curing bonding or thermosetting bonding or AB glue bonding or hot-melt adhesive film bonding or welding; and the bonding between the metal matrix (1) and the waterproof sound-permeable membrane (3) includes but is not limited to the above bonding.
